(19) United States
(12) Patent Application Publication
(10) Pub. No.: US 2020/0143511 A1
(43) Pub. Date: May 7, 2020

(54) PANORAMIC VIDEO MAPPING METHOD BASED ON MAIN VIEWPOINT

(71) Applicant: PEKING UNIVERSITY SHENZHEN GRADUATE SCHOOL, Shenzhen (CN)

(72) Inventors: Ronggang WANG, Shenzhen (CN); Yueming WANG, Shenzhen (CN); Zhenyu WANG, Shenzhen (CN); Wen GAO, Shenzhen (CN)

(21) Appl. No.: 16/478,607

(22) PCT Filed: Aug. 4, 2017
(86) PCT No.: PCT/CN2017/095984

§ 371 Date: Jan. 6, 2020

(30) Foreign Application Priority Data
Jan. 17, 2017 (CN) 201710031017.7

(51) Int. Cl. G06T 3/00

(52) U.S. Cl. CPC G06T 3/0062; G06T 3/0075; G06T 3/005

(57) ABSTRACT

Disclosed are a panoramic video forward mapping method and a panoramic video inverse mapping method, which relates to the field of virtual reality (VR) videos. In the present disclosure, the forward mapping method comprises: mapping, based on a main viewpoint, the Areas I, II, and III on the sphere onto corresponding areas on the plane, wherein Area I corresponds to the area with the included angle 0°˜Z₁, the Area II corresponds to the area with the included angle Z₁˜Z₂, and the Area III corresponds to the area with the included angle Z₂˜180°. The panoramic video forward mapping method refers to mapping a spherical source corresponding to the panoramic image A onto a plane square image B; the panoramic video inverse mapping method refers to mapping the plane square image B back to the sphere for being rendered and viewed. the present disclosure may significantly lower the resolution of a video, effectively lower the code rate for coding the panoramic video and reducing the complexity of coding and decoding, further achieving the objective of lowering the code rate and guaranteeing video quality of the ROI area.

### FIELD

Embodiments of the present relate to the field of virtual reality (VR) videos, and more particularly relate to a main viewpoint-based panoramic video mapping method applied to a panoramic video, which may significantly reduce the file size and code rate of the panoramic video while maintaining quality of the main viewpoint area thereof.

### BACKGROUND

Constant growth of virtual reality (VR) technologies boosts the increasing demand on VR videos. A panoramic video provides a 360° visual scope; however, a viewer can only view a certain area of the video during a period of time. In such cases, the video area viewed by the viewer may be referred to as a main viewpoint area, which is always part of the 360° panoramic video.

As a 360° panoramic image requires a wider angle of view (AOV), it requires a higher resolution than conventional planar videos; besides, the code rate required for coding is also much higher; as such, the complexity of video coding/decoding is greatly raised. Conventional mapping methods can hardly lower the code rate for coding a panoramic video and the complexity of coding/ decoding of the panoramic video, and can hardly guarantee video quality of a main viewpoint area.

### SUMMARY

To overcome the drawbacks in the prior art, the present disclosure provides a novel panoramic image forward mapping method and a corresponding inverse mapping method, wherein the panoramic image forward mapping method may significantly lower the resolution of a video while maintaining the video quality of a main viewpoint area, thereby effectively lowering the code rate for coding the panoramic video and reducing the complexity of coding and decoding, further guaranteeing video quality of the main viewpoint area. The panoramic image inverse mapping technology provides a method of mapping a plane back to a sphere, which enables rendering and viewing the plane image in the present disclosure.

A technical solution of the present disclosure is provided below:

A main viewpoint-based panoramic video forward mapping method comprises: mapping a sphere corresponding to a panoramic image A to a plane square image B; supposing the longitude-latitude of the main viewpoint center are (lon, lat), partitioning the sphere into three areas according to an included angle from the main viewpoint center to the spherical center, respectively denoted as Area I, Area II, and Area III, wherein the Area I corresponds to an area with an angle of 0°˜Z₁, the Area II corresponding an area with an angle of Z₁˜Z₂, and the Area III corresponds to an area with an angle of Z₂˜180°; then mapping the Area Ito a circle on the image B with the image center as the circle center and ρ₀ as the radium; mapping the Area II to a circle on the image B with the image center as the circle center, ρ₀ as the inner radium, and the outer radium being half of the image size; mapping the Area III to four ¼ circles with the four corners of the image B as respective centers, each of the ¼ circle being tangent with the outer ring of the circle corresponding to the Area II; particularly, when Z₁=0°, ρ₀=0, and at this point, the Area I does not exist while only the Area II and the Area III exist; when Z₁=Z₂, ρ₀ is half of the image size, and at this point, the Area II does not exist while only the Area I and the Area III exist; after mapping using the above method, part of areas in the Image B are not used, which may be filled with any pixel value.

For the panoramic video forward mapping process, the mapping the sphere corresponding to the panoramic image A to the plane square image B (with a resolution of N×N) specifically further comprises: for each pixel point (X, Y) in the plane image B, computing its spherical coordinates

Coordinate based on (X, Y), the relation between the spherical coordinates Coordinate and the (X, Y) may be expressed as: Coordinate=F(X, Y)=f_{T}(f_{M}(X, Y)), where f_{M} denotes coordinates of the pixel point (X , Y) in the plane image B after being mapped to the sphere when the main viewpoint center is at North Latitude 90° (or South Latitude 90°), corresponding to step 11) below; f_{T} denotes a rotating operation, corresponding to step 12) below; then, taking the pixel value at a corresponding position on the sphere (or obtaining a corresponding pixel value by interpolating a nearby pixel value) based on the spherical coordinates Coordinate as the pixel value of the pixel point (X, Y) in the plane image B. The above method specifically includes steps 11)—13) below:

11) computing the coordinates of the pixel point (X, Y) in the plane image B after being mapped to the sphere when the main viewpoint center is at North Latitude 90°, specifically comprising steps of:

A) computing the distance ρ from each pixel point (X, Y) in the plane image B to the center of the plane image B;

B) determining the area where the pixel point (X, Y) is located based on the value of ρ; when the pixel point (X, Y) is in the Area I or the Area II, turning to step C); otherwise, computing the distances from the pixel point (X, Y) to the four corners of the image, and taking the shortest distance, denoted as ρ′; determining whether the pixel point (X, Y) is in the Area III based on the value of ρ′; when the pixel point (X, Y) is in the Area III, turning to step C); when the pixel point (X, Y) is not in the Area III, the pixel point (X, Y) is an unused pixel, which may be filled with any value (if the pixel is proximal to the boundary between the Area II and the Area III, it may be preferably filled with the value of a pixel on the boundary between the Area II and the Area III, or the pixel value may be computed according to the mapping manner of Area II or Area III); then terminating the operation;

C) computing the value of the included angle Z between the current point and the main viewpoint center based on the area where the pixel point (X, Y) is located and the value of ρ or ρ′;

D) computing the latitude corresponding to the pixel point (X, Y) based on the equation latitude=90°−Z (if the main viewpoint center is at North Latitude 90°) or latitude=−90°+Z (if the main viewpoint center is at South Latitude 90°);

E) if the pixel point (X, Y)is in the Area I or the Area II, computing the longitude longitude of the current pixel point based on the direction with the longitude of 0° selected from the Area I or the Area II on the plane (the direction with the longitude of 0° may be initiatively set) and the value of X, Y; if the pixel point (X, Y) is in the Area III, computing the longitude longitude of the current pixel point based on the angles corresponding to the four ⅓ circles (the corresponding angles may be initiatively set, but required to cover the entire 360° scope) and the value of X, Y;

F) obtaining the coordinates of the pixel point on the sphere based on the longitude-latitude of the pixel point; the coordinates being the corresponding coordinates of the pixel point (X, the plane image B after being mapped on the sphere when the main viewpoint center is at North Latitude 90° or at South Latitude 90°;

12) rotating the coordinates obtained in step F) to obtain the coordinates corresponding to the pixel point (X, Y) in the plane image B when the main viewpoint center is (lon, lat);

13) taking the pixel value of the corresponding position on the sphere (or obtaining the corresponding value by interpolation) based on the rotated coordinates in step 2) as the pixel value of the pixel value point (X, Y) in the plane image B.

For the panoramic video forward mapping process, further, mapping formats of the panoramic image A include, but are not limited to, a longitude-latitude image, a cubic mapping image, a multi-channel camera captured panoramic video.

For the panoramic video forward mapping process, further, the values of parameters lon, lat, Z₁, Z₂ and ρ₀ in the method may all be initiatively set.

For the panoramic video forward mapping process, further, the step A) of computing the distance p from the pixel point (X, Y) in the plane image B to the center of the plane image B specifically comprises: normalizing the pixel point (X, Y) in the plane image B to a range from −1 to 1, wherein the normalized coordinates are (X′, Y′); then, computing the distance ρ=\sqrt{(X′)²+(Y′)²} from the point (X′, Y′) to the center of the plane image B.

For the panoramic video forward mapping process, further, the step B) of determining the area where the pixel point (X, Y) is located comprises: when ρ<ρ₀, the pixel point (X, Y) is in the Area I; when 1≥ρ>ρ₀, the pixel point (X, Y) is in the Area II; when ρ>1, computing the distances from the pixel point (X, Y) to the four corners of the plane image B; taking the shortest distance, denoted as ρ′; when ρ′\sqrt{2}−1, the pixel point (X, Y) is in the Area III; when ρ′>\sqrt{2}−1, the pixel point (X, Y) in the plane image B is an unused pixel, which may be filled with any value (if the pixel is proximal to the boundary between the Area II and the Area III, it may be preferred filled with the value of a pixel on the boundary between the Area II and the Area III, or computing its pixel value based on the mapping manner of Area II or Area III). In the above steps, a point satisfying ρ=ρ₀ may be assigned to Area I or Area II;

For the panoramic video forward mapping process, further, the step C) of computing the value of the azimuth Z based on the area where the pixel point (X, Y) is located and the value of ρ or ρ′ comprises: if the pixel point (X, Y) is in the Area I, the azimuth is

$$Z = 2 arcsin \frac{ρ}{{c}_{0}} ,$$

wherein C₀ is determined by a boundary condition: when ρ=ρ₀, Z=Z₁; if the pixel point (X, Y) is in the Area II, the azimuth Z is solved by ρ²=C₁+C₀∫sinZ f₁(Z)dZ, wherein the C₀, C₁ in the equation are determined by boundary conditions: when ρ=ρ₀, Z=Z₁ and when ρ=1, Z=Z₂; if the pixel point (X, Y) is in the Area III, the azimuth Z is solved by ρ′²=C₁+C₀∫sinZ f₂ (Z) dZ , wherein C₀ , C₁ in the equation are determined by boundary conditions when ρ′=0, Z=180° and when ρ′=\sqrt{2}−1, Z=Z₂; in the above step, f₁(Z) and f₂(Z) are any functions of Z.

For the panoramic video forward mapping process, further, the step 12) of rotating specifically comprises: computing rectangular coordinates (Xₛₚₕₑᵣₑ, Yₛₚₕₑᵣₑ, Zₛₚₕₑᵣₑ) of a point on a unit sphere based on the longitude-latitude; then multiplying the coordinates (Xₛₚₕₑᵣₑ, Yₛₚₕₑᵣₑ, Zₛₚₕₑᵣₑ) by a rotation matrix (the rotation matrix satisfies the following conditions: the coordinates obtained by multiplying the coordinates of the point of North Latitude 90° (or South Latitude 90°) by the rotation matrix are the coordinates at the main viewpoint center (lon, lat)) to obtain the corresponding rectangular coordinates (Xₛₚₕₑᵣₑ′, Yₛₚₕₑᵣₑ′, Zₛₚₕₑᵣₑ′) of the pixel point (X, Y) in the plane image B after being mapped to the sphere (the corresponding longitude-latitude may also be solved based on the rectangular coordinates).

In another aspect, the present disclosure provides a panoramic video inverse mapping process, comprising: mapping a plane square image B back to a sphere; supposing the longitude-latitude of main viewpoint center of the square image B are (lon, lat), Area I is a circle on the image B with the image center as the circle center and the radius of ρ₀, corresponding to an area on the sphere with an included angle relative to the connecting line from the spherical center to the main viewpoint center being 0°˜Z₁; the Area II is a circular ring on the image B with the image center being the circle center, the inner radium being ρ₀, the outer radium being a half of the image size, corresponding to an area on the sphere with the included angle relative to the connecting line from the spherical center to the main viewpoint center being Z₁˜Z₂; the Area III are four ¼ circles with the four corners of the image B as respective circle centers, each of the four ¼ circles being tangent with the outer perimeter of the circle corresponding to the Area II, corresponding to the area with an included angle relative to the connecting line from the corresponding spherical center to the main viewpoint center being Z₂˜180°, wherein the values of parameters lon, lat, Z₁, Z₂ and ρ₀ are obtained from the code rate, but not included thereto.

The panoramic video inverse mapping method specifically comprises: for a point on the sphere, computing its corresponding coordinates (X, Y) on a plane based on its coordinates Coordinate, wherein the relation between the plane coordinates (X, Y) and the Coordinate is expressed as (X, Y)=F′(Coordinate)=f_{M}′(f_{T}′(Coordinate)), where f_{T}′ represents the step 21) corresponding to the rotating operation; f_{M}′ represents the mapping operation, corresponding to the steps 22) to 24); then, taking a pixel value at the corresponding position on the plane based on the plane coordinates (X, Y) (or obtaining the corresponding pixel value by interpolating a nearby pixel) as the pixel value for the pixel point at the Coordinate position on the sphere; the spherical coordinate Coordinate may be expressed as (longitude′, latitude′) or (Xₛₚₕₑᵣₑ′, Yₛₚₕₑᵣₑ′, Zₛₚₕₑᵣₑ′); the method specifically comprises steps of:

21) rotating the point on the sphere to obtain the corresponding longitude-latitude (longitude, latitude)supposing that the current main viewpoint center is at North Latitude 90° (or South Latitude 90°);

22) computing the included angle Z relative to the North Latitude 90° (or South Latitude 90°) based on the latitude Latitude, and then determining the area (Area I, Area II, or Area III) where the current point is located based on the value of Z.

23) computing the distance ρ from the current point mapped to the plane to the center of the plane image B or the shortest distance ρ′ among the distances from the current point mapped to the plane to the four corners of the plane image B based on the area corresponding to the current point and the value of Z;

24) solving the coordinates (X, Y) of the current point after being mapped to the plane image B based on the ρ or ρ′ solved in step 23) and the longitude Longitude;

25) taking the pixel value at the position of (X, Y) on the plane image B (or performing interpolation to a nearby pixel) as the pixel value of the point with coordinates (longitude′, latitude′) or (Xₛₚₕₑᵣₑ′, Yₛₚₕₑᵣₑ′, Zₛₚₕₑᵣₑ′) on the sphere;

For the panoramic video inverse mapping process, the step 21) of rotating further specifically comprises: converting the spherical coordinates (longitude′, latitude′)or (Xₛₚₕₑᵣₑ′, Yₛₚₕₑᵣₑ′, Zₛₚₕₑᵣₑ′) into rectangular coordinates (Xₛₚₕₑᵣₑ′, Yₛₚₕₑᵣₑ′, Zₛₚₕₑᵣₑ′); multiplying the coordinates (Xₛₚₕₑᵣₑ′, Yₛₚₕₑᵣₑ′, Zₛₚₕₑᵣₑ′) by a rotation matrix (the rotation matrix satisfies the following condition: rotating the point at the main viewpoint center (lon, lat) to the North Latitude 90° (or South Latitude 90°) to obtain the rotated rectangular coordinates (Xₛₚₕₑᵣₑ, Yₛₚₕₑᵣₑ, Zₛₚₕₑᵣₑ); then, computing the corresponding longitude-latitude (longitude, latitude) based on the rectangular coordinates (Xₛₚₕₑᵣₑ, Yₛₚₕₑᵣₑ, Zₛₚₕₑᵣₑ).

For the panoramic video inverse mapping process, the step 22 of computing the included angle Z relative to the North Latitude 90° (or South Latitude 90°) based on the latitude Latitude and then determining the area (Area I, Area II, or Area III) where the current point is located) based on the value of Z specifically comprises: computing the value of Z based on the equation Z=90°−latitude (if the main viewpoint center is at North Latitude 90°) or Z=latitude+90° (if the main viewpoint center is at South Latitude 90°); if 0°≤Z<Z₁, it is located in Area I; if Z₁<Z<Z₂, it is located in Area II; if Z₂<Z≤180°, it is located in Area III; if Z=Z₁, it may be assigned to Area I or Area II; if Z=Z₂ , it may be assigned to Area II or Area III; it is required to be consistent with forward mapping.

For the panoramic video inverse mapping process, the step 23) of computing the distance ρ from the current point mapped to the plane to the center of the plane image B or the shortest distance ρ′ among the distances from the current point mapped to the plane to the four corners of the plane image B based on the area corresponding to the current point and the value of Z specifically comprises: when the current point is located in the Area I, ρ is computed based on the equation

$$ρ = {C}_{0} sin \frac{Z}{2} ,$$

wherein C₀ is determined by the boundary condition: when ρ=ρ₀, Z=Z₁; when the current point is located in Area II, ρ is obtained by solving the equation ρ²=C₁+C₀∫sinZ f₁(Z)dZ, wherein C₀, C₁ is determined by the boundary conditions: when ρ=ρ₀, Z=Z₁ and when ρ=1, Z=Z₂; when the current point is located in the Area III, ρ′ is obtained by solving the equation ρ′²=C₁+C₀∫sinZ f₂(Z)dZ, wherein C₀, C₁ are determined by the boundary conditions: when ρ′=0, Z=180° and when ρ′=\sqrt{2}−1, Z=Z₂ . In the step above, f₁(Z) and f₂(Z) are any functions of Z.

For the panoramic video inverse mapping process, the step 24) of solving the value of (X, Y) further specifically comprises: if the point is in Area I or Area II, obtaining the included angle between the current point and the direction of longitude 0° selected in the Area I or Area II on the plane based on longitude, solving the value of the coordinates (X, Y) of the current point mapped to the plane based on the value of the included angle and the value of ρ; if the point is located in Area III, obtaining the value of the coordinates (X, Y) of the current point mapped to the plane based on the values of longitude and ρ′, and the angles corresponding to the four ¼ circles. The direction of the longitude 0° selected from the Area I or the Area II and the angle corresponding to the four ¼ circles should be consistent with the forward mapping process.

In the embodiment of the present disclosure, the main viewpoint-based panoramic video mapping method comprises a panoramic video forward mapping process and a panoramic video inverse mapping process; through the steps of the forward mapping process, the image A (an area on the sphere) is mapped to the plane image B (corresponding area on the plane); through the steps of the inverse mapping process, the plane image B may be mapped back to the sphere for being rendered and viewed.

Compared with the prior art, the present disclosure has the following beneficial effects:

the present disclosure provides a novel panoramic image forward mapping method and a corresponding inverse mapping method, which may significantly lower the resolution of a video while maintaining the video quality of a main viewpoint area, thereby effectively lowering the code rate for coding the panoramic video and reducing the complexity of coding and decoding the same, further guaranteeing video quality of the main viewpoint area.

Specifically, the present disclosure has the following advantages:

(1) In the present disclosure, panoramic image mapping parameters Z₁, Z₂, ρ₀, f₁(Z) and f₂(Z) are all adjustable, i.e., the scope of the main viewpoint region and the variation rate of sampling density are adjustable.

(2) if the mapping parameters Z₁, Z₂, ρ₀, f₁(Z) and f₂(Z) are selected reasonably (for example, Z₁=60°, Z₂=90°, ρ₀=sin60°,

$${f}_{1} ( Z ) = {f}_{2} ( Z ) = cos \frac{Z}{2} ) ,$$

the present disclosure may not only guarantee that the main viewpoint region has a good quality, but also may effectively lower the sampling density of the non-main viewpoint area, thereby significantly reducing the resolution of image and effectively lowering the code rate of coding the panoramic video and the complexity of coding/decoding

Under the above parameter conditions, a 4096×2048 image is mapped to a 1536×1536 image, and the number of pixels is reduced by about 72%, the code rate required for coding is lowered by about 55%, while the video quality of the main viewpoint area maintains substantially unchanged.

(3) The inverse mapping method enables the plane image B in the present disclosure to be mapped back to a sphere for being rendered and viewed.

### DRAWINGS

FIG. 1 shows a schematic diagram of a correspondence relationship between a plane image and a sphere by panoramic image mapping, wherein through on the panoramic image forward mapping method provided by the present disclosure, the Areas I, II, and III on the sphere are mapped to the Areas I, II, and III on the plane, respectively; through the panoramic image inverse mapping method provided by the present disclosure, the Areas I, II, and III on the plane are mapped to the Areas I, II, and II on the sphere, respectively;

wherein (a) is a schematic diagram of a panoramic image on a sphere; (b) is a schematic diagram of the image mapped using the method of the present disclosure; Area I in (a) refers to the main viewpoint area with point C as the center, which corresponds to the area from 0° to Z₁; Z₁ denotes the ° of ∠BOC in (a), which may be initiatively set; in the present disclosure, the Area I in (a) is mapped to a circular surface in Area I in (b), wherein the radius of the circular surface in Area I in (b) is ρ₀, which may be initiatively set; the Area II on the (a) sphere is a first-stage non-viewpoint area, which corresponds to the area from Z₁ to Z₂, where Z₂ denotes the ° of ∠AOC in (a), which may be initiatively set; in the present disclosure, Area II in (a) is mapped to a circular ring in Area II in the square of (b); Area III on the (a) sphere is a second-stage non-viewpoint area, which corresponds to the area from R′ to 180°; in the present disclosure, the Area III in (a) is mapped to the circular face in Area III in the square of (b), where the circular face in Area III in the square comprises four ¼ circular faces; areas other than Area I, Area II, and Area III in the square of (b) are unused areas, which may be filled with any pixel values.

FIG. 2 is a schematic diagram of correspondence between the mapping and the sizes on the sphere in the present disclosure, wherein (a) is a schematic diagram of computing the size of a small block of area on the sphere; (b) is a schematic diagram of computing the size of a small block of area on a plane; wherein the size of the smaller area on a unit sphere may be denoted as Sₛₚₕₑᵣₑ=sinZdαdZ, which, after being mapped to the circular face in the plane, has a corresponding size of S_{circular surface}=ρdαdρ; the ratio between the two sizes is

$$\frac{{s}_{circular surface}}{{s}_{sphere}} = \frac{ρ d ρ}{sin ZdZ} ;$$

when the ratio is a constant, i.e.,

$$\frac{ρ d ρ}{sin ZdZ} = C ,$$

the relation between ρ and Z is solved to be

$$ρ = {C}_{0} sin \frac{Z}{2} ,$$

which guarantees that the sampling density in the main viewpoint area is consistent; if the ratio is a function f(Z) whose value increases, not incrementing, with Z, i.e.,

$$\frac{ρ d ρ}{sin ZdZ} = f ( Z ) ,$$

the relation between ρ and Z is solved to be ρ²=C₁+C₀∫sinZ f(Z)dZ, which guarantees that the farther from the main viewpoint area, the lower the sampling density.

FIG. 3 is a flow diagram of the forward mapping method according to the present disclosure;

FIG. 4 is a flow diagram of the inverse mapping method according to the present disclosure;

FIG. 5 is a schematic diagram of computing forward mapping and inverse mapping in an embodiment of the present disclosure;

wherein, Area I and Area II choose the direction with the longitude being 0° as the forward direction of X axis; and the correspondence relationship with respect to the longitude in Area III is obtained through map computing.

FIG. 6 is a effect diagram resulting from forward mapping according to an embodiment of the present disclosure.

### DETAILED DESCRIPTION OF THE PREFERRED EMBODIMENTS

Hereinafter, the present disclosure is further described through the embodiments, but the scope of the present disclosure is not limited in any manner.

An embodiment of the present disclosure provides a main viewpoint-based panoramic image mapping method, comprising a panoramic image forward mapping method and a corresponding inverse mapping method, embodiments of which will be explained below, respectively.

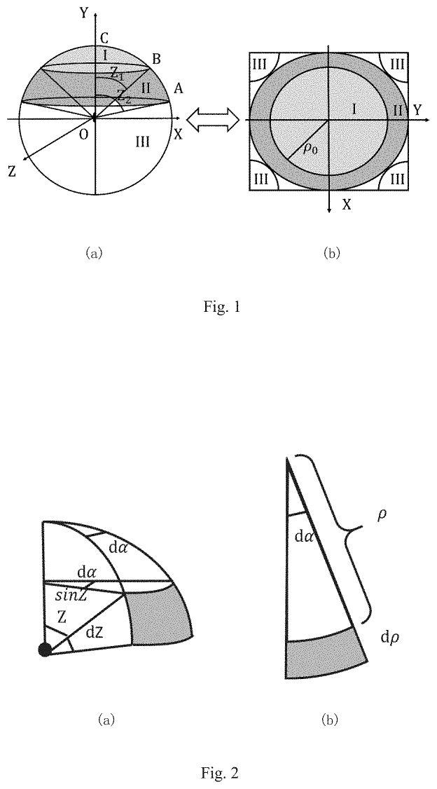

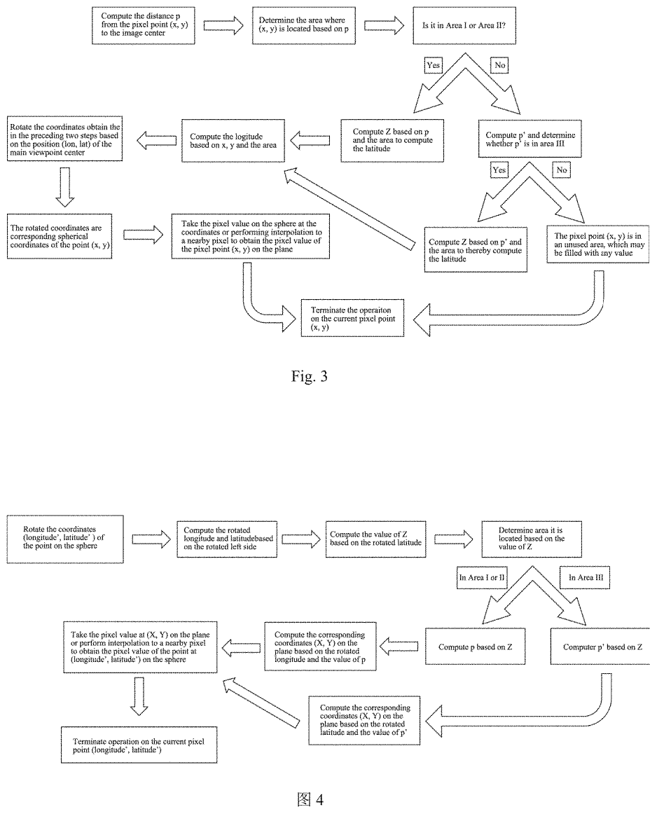

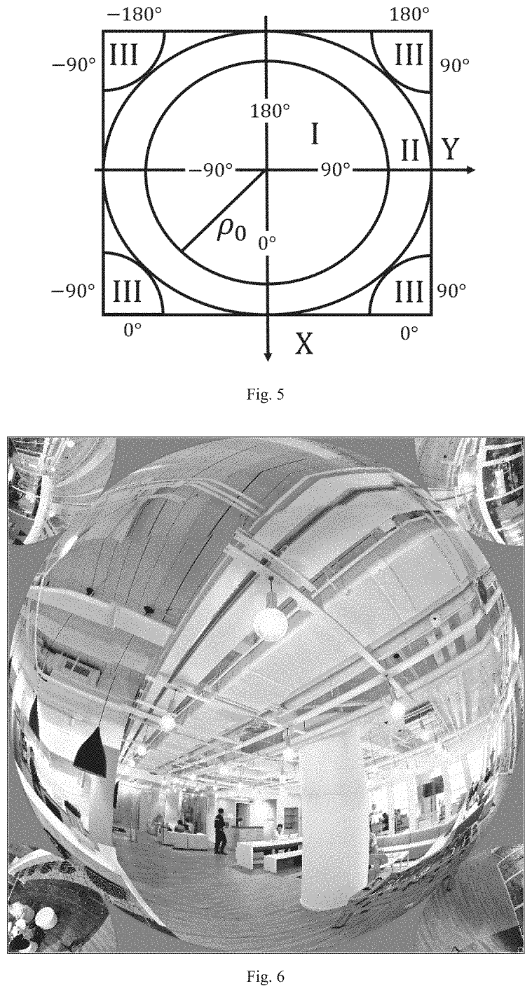

The panoramic image forward mapping method is shown in FIG. 1, wherein Areas I, II, and III on the sphere are mapped to the Areas I, II, and III on the plane, respectively; In FIG. 1, the left part is a schematic diagram of a panoramic image on a sphere, and the right part is a schematic diagram of an image mapped using the method of the present disclosure. Area I in (a) refers to the main viewpoint area with point C as the center, which corresponds to the area from 0° to Z₁; Z₁ denotes the ° of ∠BOC in (a), which may be initiatively set; in the present disclosure, the Area I in (a) is mapped to a circular surface in Area I in (b), wherein the radius of circular surface in Area I in (b) is ρ₀, which may be initiatively set; the Area II on the (a) sphere is a first-stage non-viewpoint area, which corresponds to the area from Z₁ to Z₂, where Z₂ denotes the ° of ∠AOC in (a), which may be initiatively set; in the present disclosure, Area II in (a) is mapped to a circular ring in Area II in the square of (b); Area III on the (a) sphere is a second-stage non-viewpoint area, which corresponds to the area from R′ to 180°; in the present disclosure, the Area III in (a) is mapped to the circular face in Area III in the square of (b), where the circular face in Area III in the square comprises four ¼ circular faces; areas other than Area I, Area II, and Area III in the square of (b) are unused areas, which may be filled with any pixel values.

As shown in FIG. 2, a size of a smaller area in a unit sphere may be expressed as SₛₚₕₑᵣₑsinZdαdZ, the corresponding size of which after being mapped to the circular face in the plane image is S_{circular surface}=ρdαdρ, wherein the ratio between the two sizes is

$$\frac{{s}_{circular surface}}{{s}_{spher}} = \frac{ρ d ρ}{sin ZdZ} .$$

In the circular face corresponding to Area I in the square, supposing the size ratio is a constant, namely,

$$\frac{ρ d ρ}{sin ZdZ} = C ,$$

the relation between ρ and Z is solved to be

$$ρ = {C}_{0} sin \frac{Z}{2} ,$$

which guarantees a consistent sampling density in the circular face of Area I in the square (i.e., in the main viewpoint area). In the circular faces corresponding to Areas II and III, the size ratio is a function f(Z) whose value increases, but not incrementing, with Z (the f(Z) functions corresponding to Area II and Area III can be different), i.e.,

$$\frac{ρ d ρ}{sin ZdZ} = f ( Z ) ;$$

then, the relation between ρ and Z is solved to be ρ²=C₁+C₀∫sinZ f(Z)dZ, which guarantees that the farther from the main viewpoint area, the lower the sampling density is.

In an embodiment, a sphere corresponding to panoramic image A of a certain format (e.g., a longitude-latitude map, a cubic map image, etc.) is mapped to a plane image B (with a resolution of N×N) corresponding to the panoramic mapping designed in the present disclosure. The specific flow is described as follows (wherein the first through sixth steps relate to computing coordinates of the pixel point (X, the plane image B after being mapped to the sphere when the main viewpoint center is at North Latitude 90°; the seventh step relates to rotating the coordinates to the coordinates corresponding to the current main viewpoint center):

Step 1: normalizing the pixel point (X, Y)in the plane image B to a range from −1 to 1, wherein the normalized coordinates are (X′, Y′) (here, it is optional not to normalize; however, normalization may facilitate derivation of subsequent equations).

Step 2: computing the distance ρ=\sqrt{(X′)²+(Y′)²} from the point (X′, Y′) to the center of the plane image B.

Step 3: if ρ≤ρ₀, the point is located in Area I, and the azimuth is

$$Z = 2 arcsin \frac{ρ}{{C}_{0}}$$

(C₀ in the equation is determined by the boundary condition: when ρ=ρ₀, Z=Z₁; if 1≥ρ>ρ₀ is located in Area II, the azimuth Z is solved by ρ²=C₁+C₀∫sinZ f₁(Z)dZ (C₀, C₁ in the equation is determined by boundary conditions: when ρ=ρ₀, Z=Z₁ and when ρ=1, Z=Z₂); if ρ>1, computing the distances from point (X′, Y′) to the four corners of the plane image B, taking the shortest distance, denoted as ρ′; if ρ′≤\sqrt{2}−1, the point is located in Area III, and the azimuth Z is solved by ρ′²=C₁+C₀∫sinZ f₂(Z)dZ (C₀, C₁ in the equation is determined by the boundary conditions: when ρ′=0, Z=180° and when ρ′=\sqrt{2}−1, Z=Z₂); if ρ′>\sqrt{2}−1, the pixel point (X, Y) in the plane image B is an unused pixel, which may be filled with any value.

Step 4: computing the latitude corresponding to the point based on the equation latitude=90°−Z, where when latitude is forward, it indicates North Latitude, when latitude is negative, it indicates South Latitude.

Step 5: computing the longitude of the current point based on the value of X′, Y′, where when the longitude is forward, it indicates East Longitude, and when the longitude is negative, it indicates West Longitude.

Step 6: obtaining the coordinates of the point on the sphere based on the longitude-latitude; i.e., when the main viewpoint center is at North Latitude 90°, the pixel point (X, Y) in the plane image B corresponds to the coordinates on the sphere.

Step 7: computing the Cartesian coordinates (Xₛₚₕₑᵣₑ, Yₛₚₕₑᵣₑ, Zₛₚₕₑᵣₑ) of the point on the unit sphere based on the longitude and the latitude; then multiplying the coordinates (Xₛₚₕₑᵣₑ′, Yₛₚₕₑᵣₑ′, Zₛₚₕₑᵣₑ′) by the rotation matrix corresponding to the main viewpoint center rotated from the North Latitude 90° to obtain the Cartesian coordinates (Xₛₚₕₑᵣₑ′, Yₛₚₕₑᵣₑ′, Zₛₚₕₑᵣₑ′) on the sphere corresponding to the pixel point (X, Y) in the plane image B (here, it is optional to directly rotate the longitude-latitude coordinates, but rotation with the Cartesian coordinates facilitates computation).

Step 8: taking the pixel value of the corresponding position on the sphere (or obtaining the corresponding value by interpolation) based on the coordinates (Xₛₚₕₑᵣₑ′, Yₛₚₕₑᵣₑ′, Zₛₚₕₑᵣₑ′) on the sphere as the pixel value of the pixel point (X, Y) in the plane image B.

FIG. 3 is a flow diagram of the forward mapping method according to the present disclosure; The specific computation for the forward mapping process in this embodiment is provided below:

Step 1: normalizing the pixel point (X, Y)in the plane image B (with a resolution of N×N) to a range from −1 to 1; the normalized coordinates are (X′, Y′); a computing equation thereof is as follows: .

$$\begin{matrix}{X}^{′} = \frac{2 X}{N} - 1 & ( Equation 1 ) \\ {Y}^{′} = \frac{2 Y}{N} - 1 & ( Equation 2 )\end{matrix}$$

Step 2: computing the distance from the point (X′, Y′)to the center of the plane image B.

ρ=\sqrt{(X′)²+(Y′)²} (Equation 3)

Particularly, prefers to a distance from the point (X′, Y′) to the center of the plane image B.

Step 3: if ρ≤ρ₀, the point is located in Area I; if 1≥ρ>ρ₀, the point is located in Area II; if ρ>1, computing distances from the point (X′, Y′) to the four corners of the plane image B, taking the shortest distance, denoted as ρ′; if ρ′≤\sqrt{2}−1 the point is located in Area III; if ρ′>\sqrt{2}−1, the pixel point (X, Y) in the plane image B is an unused pixel, which may be filled with any value; then, directly skipping off the subsequent steps. If the point is located in Areas I, II, and III, solving the value Z based on the relationship between ρ or ρ′ and Z, the computed relations are provided below:

$$\begin{matrix}in Area I \text{:} Z = 2 arcsin \frac{{ρ}_{0}}{{C}_{0}} & ( Equation 4 ) \\ in Area II \text{:} {ρ}^{2} = {C}_{1} + {C}_{0} \int sin Z {f}_{1} ( Z ) dZ & ( equation 5 ) \\ In Area III \text{:} {ρ}^{′2} = {C}_{1} + {C}_{0} \int sin Z {f}_{2} ( Z ) dZ & ( equation 6 )\end{matrix}$$

C₀, C₁in the above equations are solved by the boundary conditions; the boundary conditions of Areas I, II, and III are provided below:

$$in Area I \text{:} 2 arcsin \frac{{ρ}_{0}}{{C}_{0}} \qquad ( equation 7 )$$

In Area II: ρ₀²=(C₁+C₀∫sinZ f₁(Z)dZ)|_{Z=Z}_{₁}

and

1²=(C₁+C₀∫sinZ f₁(Z)dZ)|_{Z=Z}_{₂} (8)

In Area III: (\sqrt{2}−1)²=(C₁+C₀∫sinZ f₂(Z)dZ)|_{Z=Z}_{₂}

and

0=(C₁+C₀∫sinZ f₂(Z)dZ)|_{Z=180°} (equation 9)

Step 4: computing the latitude latitude corresponding to the point based on Z, where when latitude is forward, it indicates North Latitude, when latitude is negative, it indicates South Latitude, the computing equation of which is provided below:

latitude=90°−Z (equation 10)

Step 5: computing the longitude of the current point based on the value of X′, Y′, where when the longitude is forward, it indicates East Longitude, and when the longitude is negative, it indicates West Longitude. The correspondence relationship between the direction of longitude 0° on the Areas I and II in the plane image B and the longitude on Area III may be initiatively set. In this embodiment, are I and Area II choose the direction with the longitude being 0° as the forward direction of X axis; and the correspondence relationship with respect to the longitude in Area III is shown in FIG. 5, the specific computing relationship is provided below:

$$\begin{matrix}In area I and II \text{:} longitude = arctan \frac{{Y}^{′}}{{X}^{′}} & ( equation 11 ) \\ in Area II \text{:} longitude = \{ \begin{matrix}- arctan \frac{{Y}^{′} + 1}{{X}^{′} + 1} - 90 ° & \frac{1}{4} circle at the left upper corner \\ - arctan \frac{{Y}^{′} + 1}{{X}^{′} - 1} - 90 ° & \frac{1}{4} corc ; e at the left lower corner \\ - arctan \frac{{Y}^{′} - 1}{{X}^{′} + 1} + 90 ° & \frac{1}{4} circle at the right upper corner \\ - arctan \frac{{Y}^{′} - 1}{{X}^{′} - 1} - 90 ° & \frac{1}{4} circle at the right lower corner\end{matrix} & ( equation 12 )\end{matrix}$$

Step 6: obtaining the coordinates of the point on the sphere based on the longitude-latitude; i.e., when the main viewpoint center is at North Latitude 90°, the pixel point (X, Y) in the plane image B corresponds to the coordinates on the sphere.

Step 7: computing the Cartesian coordinates (Xₛₚₕₑᵣₑ′, Yₛₚₕₑᵣₑ′, Zₛₚₕₑᵣₑ′) of the point on a unit sphere based on the longitude-latitude (X-axis, Y-axis, and Z-axis of the coordinate system are shown in FIG. 1), which is computed as follows:

Xₛₚₕₑᵣₑ=sin(longitude)×cos(latitude) (equation 13)

Yₛₚₕₑᵣₑ=sin(latitude) (equation 14)

Zₛₚₕₑᵣₑ=cos(longitude)×cos(latitude) (equation 15)

Then, multiplying the coordinates (Xₛₚₕₑᵣₑ, Yₛₚₕₑᵣₑ, Zₛₚₕₑᵣₑ) by the rotation matrix corresponding to the main viewpoint center rotated from the North Latitude 90° to obtain the Cartesian coordinates (Xₛₚₕₑᵣₑ′, Yₛₚₕₑᵣₑ′, Zₛₚₕₑᵣₑ′) on the sphere corresponding to the pixel point (X, Y) in the plane image B.

Step 8: taking the pixel value of the corresponding position on the sphere (or obtaining the corresponding value by interpolation) based on the coordinates (Xₛₚₕₑᵣₑ′, Yₛₚₕₑᵣₑ′, Zₛₚₕₑᵣₑ′) on the sphere as the pixel value of the pixel point (X, Y) in the plane image B.

Till now, all steps of the embodiment of the forward mapping process are completed. The illustrative effect of this embodiment is shown in FIG. 6.

In another aspect, the panoramic image inverse mapping process maps the plane square image B back to the sphere. In this embodiment, the longitude-latitude of main viewpoint center of the square image B is (lon, lat)with a resolution of N×N, wherein Area I is a circle on the image B with the image center as the circle center and the radius of ρ₀, corresponding to an area on the sphere with an included angle relative to the connecting line from the spherical center to the main viewpoint center being 0°˜Z₁; the Area II is a circular ring on the image B with the image center being the circle center, the inner radium being ρ₀, the outer radium being a half of the image size, corresponding to an area on the sphere with the included angle relative to the connecting line from the spherical center to the main viewpoint center being Z₁˜Z₂; the Area III are four ¼ circles with the four corners of the image B as respective circle centers, each of the four ¼ circles being tangent with the outer perimeter of the circle corresponding to the Area II, corresponding to the area with an included angle relative to the connecting line from the corresponding spherical center to the main viewpoint center being Z₂˜180°, wherein the values of parameters lon, lat, Z₁, Z₂ and ρ₀ are obtained from the code rate, but not included thereto.

FIG. 4 is a flow diagram of the inverse mapping method according to the present disclosure; The specific inverse mapping process specifically comprises steps of:

Step 1: converting the coordinates of the point with coordinates (longitude′, latitude′)or (Xₛₚₕₑᵣₑ′, Yₛₚₕₑᵣₑ′, Zₛₚₕₑᵣₑ′) on the sphere to the rectangular coordinates (Xₛₚₕₑᵣₑ′, Yₛₚₕₑᵣₑ′, Zₛₚₕₑᵣₑ′), the computing equations are provided below (the X-axis, Y-axis, and Z-axis of the coordinate system are shown in FIG. 1, if the input is (Xₛₚₕₑᵣₑ′, Yₛₚₕₑᵣₑ′, Zₛₚₕₑᵣₑ′) conversion would be unnecessary):

Xₛₚₕₑᵣₑ′=sin(longitude′)×cos(latitude′) (16)

[symbol]

=sin(latitude′) (17)

Zₛₚₕₑᵣₑ′=cos(longitude′)×cos(latitude′) (18)

Step 2: multiplying the coordinates (Xₛₚₕₑᵣₑ′, Yₛₚₕₑᵣₑ′, Zₛₚₕₑᵣₑ′) by the corresponding rotation matrix resulting from rotating from the main viewpoint center (lon, lat) to the North Latitude 90° (or South Latitude 90°), to obtain the rotated rectangular coordinates (Xₛₚₕₑᵣₑ″, Yₛₚₕₑᵣₑ″, Zₛₚₕₑᵣₑ″);

Step 3: normalizing (Xₛₚₕₑᵣₑ″, Yₛₚₕₑᵣₑ″, Zₛₚₕₑᵣₑ″), the normalized rectangular coordinates are (Xₛₚₕₑᵣₑ, Yₛₚₕₑᵣₑ, Zₛₚₕₑᵣₑ), the computing relationship thereof being provided below:

$$( {X}_{sphere } , {Y}_{sphere} , {Z}_{sphere} ) = \frac{( {X}_{sphere}^{″} , {Y}_{sphere}^{″} , {Z}_{sphere}^{″} )}{\sqrt{{( {X}_{sphere}^{″} )}^{2} + {( {Y}_{sphere}^{″} )}^{2} + {( {Z}_{sphere}^{″} )}^{2}}} \qquad ( equation 19 )$$

Step 3: computing the corresponding longitude-latitude (longitude, latitude)based on the rectangular coordinates (Xₛₚₕₑᵣₑ, Yₛₚₕₑᵣₑ, Zₛₚₕₑᵣₑ), the computing relationship thereof being provided below:

$$\begin{matrix}latitude = arcsin ( {Y}_{sphere} ) & ( equation 20 ) \\ longitude = arctan ( \frac{{X}_{sphere}^{′}}{{Z}_{sphere}^{′}} ) & ( 21 )\end{matrix}$$

Step 4: computing the included angle between the current point and the main viewpoint center based on the equation Z=90°−latitude

Step 5: determining the area where the current point is located based on the value of Z; in the case of 0°≤Z≤Z₁, it is located in Area I; in the case of Z₁<Z≤Z₂, it is located in Area II; and in the case of Z₂<Z≤180°, it is located in Area III.

Step 6: if the point is located in Areas I or II, computing the distance ρ from the current point after being mapped to the plane to the center of the plane image B; if the point is in Area III, computing the shortest distance ρ′ among the distances from the current point after being mapped to the plane to the four corners of the plane image B, wherein ρ or ρ′ is solved by the following equation:

$$\begin{matrix}in Area I \text{:} Z = 2 arcsin \frac{{ρ}_{0}}{{C}_{0}} & ( equation 22 ) \\ in Area II \text{:} {ρ}^{2} = {C}_{1} + {C}_{0} \int sin Z {f}_{1} ( Z ) dZ & ( 23 ) \\ In Area III \text{:} {ρ}^{′2} = {C}_{1} + {C}_{0} \int sin Z {f}_{2} ( Z ) dZ & ( equation 24 )\end{matrix}$$

C₀, C₁in the above equations are solved by the boundary conditions; the boundary conditions are provided below:

$$\begin{matrix}in Area I \text{:} {Z}_{1} = 2 arcsin \frac{{ρ}_{0}}{{C}_{0}} & ( equation 25 ) \\ in Area II \text{:} {ρ}_{0}^{2} = ( {C}_{1} + {C}_{0} \int sin Z {f}_{1} ( Z ) dZ ) {\vert}_{Z = {Z}_{1}} and \\ {1}^{2} = ( {C}_{1} + {C}_{0} \int sin Z {f}_{1} ( Z ) dZ ) {\vert}_{Z = {Z}_{2}} & ( equation 26 ) \\ In Area III \text{:} {( \sqrt{2} - 1 )}^{2} = ( {C}_{1} + {C}_{0} \int sin Z {f}_{2} ( Z ) dZ ) {\vert}_{Z = {Z}_{2}} and \\ 0 = ( {C}_{1} + {C}_{0} \int sin Z {f}_{2} ( Z ) dZ ) {\vert}_{Z = 180 °} & ( equation 27 )\end{matrix}$$

Step 7: computing the coordinates (X, Y) of the current point on the plane based on the values of longitude, ρ or ρ′; specifically, if the point is in Area I or Area II, obtaining the included angle between the current point and the direction of longitude 0° selected in the Area I or Area II on the plane based on longitude, solving the value of the coordinates (X, Y) of the current point mapped to the plane based on the value of the included angle and the value of ρ; if the point is located in Area III, obtaining the value of the coordinates (X′, Y′) of the current point mapped to the plane based on the values of longitude and ρ′, and the angles corresponding to the four ¼ circles. In this embodiment, are I and Area II choose the direction with the longitude being 0° as the forward direction of X axis; and the correspondence relationship with respect to the longitude in Area III is shown in FIG. 5, the specific computing relationship is provided below:

$$\begin{matrix}In Areas I and II : {X}^{′} = ρ cos ( longitude ) , {Y}^{′} = ρ sin ( longitude ) & ( Equation 28 ) \\ In Area III : \{ \begin{matrix}\begin{matrix}{X}^{′} = {ρ}^{′} cos ( - longitude - 90 ° ) - 1 \\ {Y}^{′} = {ρ}^{′} sin ( - longitude - 90 ° ) - 1\end{matrix} & \frac{1}{4} cirle at the lef t upper corner \\ \begin{matrix}{X}^{′} = {ρ}^{′} cos ( 90 ° - longitude ) + 1 \\ {Y}^{′} = {ρ}^{′} cos ( 90 ° - longitude ) - 1\end{matrix} & \frac{1}{4} cirle at the lef t lower corner \\ \begin{matrix}{X}^{′} = {ρ}^{′} cos ( 90 ° - longitude ) + 1 \\ {Y}^{′} = {ρ}^{′} sin ( 90 ° - longitude ) + 1\end{matrix} & \frac{1}{4} cirle at the right upper corner \\ \begin{matrix}{X}^{′} = {ρ}^{′} cos ( - longitude - 90 ° ) + 1 \\ {Y}^{′} = {ρ}^{′} sin ( - longitude - 90 ° ) + 1\end{matrix} & \frac{1}{4} cirle at the right lower corner\end{matrix} & ( Equation 29 )\end{matrix}$$

Step 8: unnormalizing the coordinates (X′, Y′) resulting from normalizing −1 to 1 ; computation of the unnormalizng is provided below:

$$\begin{matrix}X = \frac{N \times ( {X}^{′} + 1 )}{2} & ( 30 ) \\ Y = \frac{N \times ( {Y}^{′} + 1 )}{2} & ( Equation 31 )\end{matrix}$$

Step 9: taking the pixel value at the position of (X, Y)on the plane image B (or performing interpolation to a nearby pixel) as the pixel value of the point with coordinates (longitude′, latitude′) or (Xₛₚₕₑᵣₑ′, Yₛₚₕₑᵣₑ′, Zₛₚₕₑᵣₑ′) on the sphere;

Till now, all steps of the forward mapping process and the inverse mapping process have been completed. The forward mapping process according to the embodiments of the present disclosure may map an image A (an area on the sphere) to a plane image B (corresponding area on the plane); while the inverse mapping process according to the embodiments of the present disclosure may map the plane image B back to the sphere for being rendered and viewed.

It needs to be noted that the embodiments as disclosed are intended to facilitating further understanding of the present disclosure; however, those skilled in the art may understand that various substitutions and modifications are possible without departing from the spirit and scope of the present disclosure. Therefore, the present disclosure should not be limited to the contents disclosed in the embodiments, but should be governed by the appended claims.

1. A panoramic video forward mapping method, comprising: mapping, based on a main viewpoint, a sphere corresponding a panoramic image A to a plane square image B; wherein the longitude-latitude of the main viewpoint center are (lon, lat), partitioning the sphere into three areas according to an included angle from the main viewpoint center to the spherical center, denoted as Area I, Area II, and Area III, respectively, wherein the Area I corresponds to an area with an angle of 0°˜Z₁, the Area II corresponding an area with an angle of Z₁˜Z₂, and the Area III corresponds to an area with an angle of Z₂˜180°; then mapping the Area I into a circle on the image B with the image center as the circle center and ρ₀ as the radium; mapping the Area II into a circle on the image B with the image center as the circle center, ρ₀ as the inner radium, and the outer radium being half of the image size; mapping the Area III into four ¼ circles with the four corners of the image B as respective centers, each of the ¼ circle being tangent with the outer ring of the circle corresponding to the Area II; when Z₁=0°, ρ₀=0, and at this point, the Area I does not exist while only the Area II and the Area III exist; when Z₁=Z₂, ρ₀ is half of the image size, and at this point, the Area II does not exist while only the Area I and the Area III exist; after forward mapping with the above method, part of region in the Image B is not used, which may be filled with any pixel value.

2. The panoramic video forward mapping method according to claim 1, comprising: the mapping the sphere corresponding to the panoramic image 1 to a plane square image B with a resolution of N×N specifically comprises: for each pixel point (X, Y) in the plane image B, comprises steps of:
1) computing the coordinate on the sphere corresponding to the pixel point (X, the plane image B when the main viewpoint center is North Latitude 90° or South Latitude 90°, specifically comprising steps of:
A) computing the distance ρ from each pixel point (X, Y) in the plane image B the plane image center;
B) determining the area where the pixel point (X, Y) is located based on the value of ρ; when the pixel point (X, Y) is in the Area I or the Area II, shifting to step C); otherwise, computing the distances from the pixel point (X, Y) to the four corners of the image, and taking the shortest distance, denoted as ρ′; determining whether the pixel point (X, Y) is in the Area III based on the value of ρ′; when the pixel point (X, Y) is in the Area III, shifting to step C); when the pixel point (X, Y) is not in the Area III, the pixel point (X, Y) is an unused pixel, which may be filled with any value; then ending the operation;
C) computing the value of the included angle Z between the current point and the main viewpoint center based on the area where the pixel point (X, Y) is located and the value of ρ or ρ′;
D) computing the latitude corresponding to the pixel point (X, Y) based on the equation latitude=−90°+Z when the main viewpoint center is North Latitude 90°) or based on equation latitude=90°−Z when the main viewpoint center is South Latitude 90°;
E) if the pixel point (X, Y)is in the Area I or the Area II, computing the longitude Longitude of the current pixel point based on the direction with the longitude of 0° selected from the Area I or the Area II on the plane and the value of X, Y; if the pixel point (X, Y) is in the Area III, computing the longitude Longitude of the current pixel point based on the angles corresponding to the four ⅓ circles and the value of X, Y, wherein the direction of the longitude of 0° in the Area I and II are initiatively set, and the longitudes corresponding to the four ¼ circles in Area III are initiatively set;
F) obtaining the coordinate of the pixel point on the sphere based on the longitude-latitude of the pixel point; the coordinate being the corresponding coordinate of the pixel point (X, the plane image B on the sphere when the main viewpoint center is North Latitude 90° or South Latitude 90°;
2) rotating the coordinate obtained in step F) to obtain the coordinate corresponding to the pixel point (X, the plane image B when the main viewpoint center is (lon, lat);
3) taking the pixel value of the corresponding position on the sphere or obtaining the corresponding value by interpolation based on the rotated coordinate in step 2) as the pixel value of the pixel value point (X, Y) the plane image B.

3. The panoramic video forward mapping method according to claim 1, wherein mapping formats of the panoramic image A include, but are not limited to, a longitude-latitude image, a cubic mapping image, a multi-channel camera captured panoramic video.

4. The panoramic video forward mapping method according to claim 4, wherein the values of parameters lon, lat, Z₁, Z₂ and ρ₀ in the method may all be initiatively set.

5. The panoramic video forward mapping method according to claim 2, wherein the step A) of computing the distance ρ from the pixel point (X, Y) in the plane image B to the center of the plane image B specifically comprises: normalizing the pixel point (X, Y) in the plane image B to a range from −1 to 1, wherein the normalized coordinate is (X′, Y′); then, computing the distance ρ=\sqrt{(X′)²+(Y′)²} from the point (X′, Y′) to the center of the plane image B.

6. The panoramic video forward mapping method according to claim 2, wherein the step B) of determining the area where the pixel point (X, Y) is located is performed as such: when ρ<ρ₀, the pixel point (X, Y) is in the Area I; when 1≥ρ>ρ₀, the pixel point (X, Y) is in Area II; when ρ>1, computing the distances from the pixel point (X, Y) to the four corners of the planar image B, taking the shortest distance therein, denoted as ρ′; when ρ′≤\sqrt{2}−1, the pixel point (X, Y) is in the Area III; when ρ′≤\sqrt{2}−1, the pixel point (X, Y) in the plane image is an unused pixel, which may be filled with any value; in the steps above, points satisfying ρ=ρ₀ are assigned to Area I or Area II.

7. The panoramic video forward mapping method according to claim 2, wherein step C) of computing the value of the included angle Z between the current point and the main viewpoint center based on the area where the pixel point (X, Y) is located and the value of ρ or ρ′ specifically comprises:
when the pixel point (X, Y) is in the Area I, computing Z based on the equation
$$Z = 2 arcsin \frac{{ρ}_{0}}{{C}_{0}} ,$$
wherein C₀ is determined by the boundary condition: when ρ=ρ₀, Z=Z₁;
when the pixel point (X, Y) is in the Area II, solving Z based on the equation ρ²=C₁+C₀∫sinZ f₁(Z)dZ , wherein C₀, C₁ is determined by the boundary conditions: when ρ=ρ₀, Z=Z₁ and ρ=1, Z=Z₂; and f₁(Z) is any function of Z;
when the pixel point (X, Y)is in the Area III, solving the azimuth Z based on the equation ρ′²=C₁+C₀∫sinZ f₂(Z)dZ , wherein C₀, C₁ is determined by the boundary conditions: when ρ′=0, Z=180° and when ρ′=\sqrt{2}−1, Z=Z₂; and f₂(Z) is any function of Z.

8. The panoramic video forward mapping method according to claim 2, wherein the rotating in step 2) specifically comprising: computing the rectangular coordinates (Xₛₚₕₑᵣₑ, Yₛₚₕₑᵣₑ, Zₛₚₕₑᵣₑ) of the point on the unit sphere based on the longitude and the latitude, then multiplying the coordinates (Xₛₚₕₑᵣₑ, Yₛₚₕₑᵣₑ, Zₛₚₕₑᵣₑ) by a corresponding rotation matrix resulting from rotating from the North Latitude 90° or South 90° to the main viewpoint center (lon, lat) to obtain the rectangular coordinates (Xₛₚₕₑᵣₑ′, Yₛₚₕₑᵣₑ′, Zₛₚₕₑᵣₑ′) on the sphere corresponding to the pixel point (X, Y) in the plane image B.

9. A panoramic video inverse mapping method, comprising: mapping, based on a main viewpoint, the plane square image B back to the sphere, wherein the longitude-latitude of the main viewpoint center of the square image B are (lon, lat), Area I refers to a circle on the image B with the image center as the circle center and a radius of ρ₀, which is inversely mapped to an area on the sphere having an included angle 0°˜Z₁ with a connecting line from the main viewpoint center to the spherical center; Area II is a circular ring on the image B which takes the image center as the circular center, with an inner radium of ρ₀ and an outer radium being half of the image size, which is inversely mapped to an area on the sphere having an included angle Z₁˜Z₂ with the connecting line from the main viewpoint center to the spherical center; Area III refer to four ¼ circles with four corners of the image B as the circle centers, each ¼ circle being tangent with the outer perimeter of the circular ring corresponding to Area II, which is inversely reflected to an area on the sphere having an included angle Z₂˜180° with the connecting line from the main viewpoint center to the spherical center; wherein when ρ₀=0, Z₁=0, and at this point, Area I does not exist while only Area II and Area III exist; when ρ₀ is half of the image size, Z₁=Z₂, and at this point, Area II does not exist while only Area II and Area III exist; values of the parameters lon, lat, Z₁, Z₂ and ρ₀ are obtained from the code rate, but not limited thereto.

10. The panoramic video inverse mapping method according to claim 9, wherein for each point on the sphere with coordinates of (longitude′, latitude′) or (Xₛₚₕₑᵣₑ′, Yₛₚₕₑᵣₑ′, Zₛₚₕₑᵣₑ′), the method of inversely mapping the plane square image B back to the sphere specifically comprise steps of:
1) rotating the point on the sphere to obtain the corresponding longitude-latitude (longitude, latitude) supposing that the current main viewpoint center is at North Latitude 90° or South Latitude 90°;
2) computing the included angle Z with the North Latitude 90° or South Latitude 90° based on the Latitude latitude, and then determining the area where the current point is located based on the value of Z;
3) computing the distance ρ from the current point mapped to the plane to the center of the plane image B or the shortest distance ρ′ among the distances from the current point mapped to the plane to the four corners of the plane image B based on the area corresponding to the current point and the value of Z;
4) solving the coordinates (X, Y)of the current point after being mapped to the plane image B based on the ρ or ρ′ solved in step 3) and the longitude longitude;
5) taking the pixel value at the position of (X, Y) on the plane image B or performing interpolation to a nearby pixel as the pixel value of the point with coordinates (longitude′, latitude′) or (Xₛₚₕₑᵣₑ′, Yₛₚₕₑᵣₑ′, Zₛₚₕₑᵣₑ′) on the sphere;
executing the steps 1)˜5) for all points on the sphere, thereby completing inverse mapping of the panoramic video.

11. The panoramic video inverse mapping method according to claim 10, wherein the step 1) of rotating further specifically comprises: converting the coordinates (longitude′, latitude′) or (Xₛₚₕₑᵣₑ′, Yₛₚₕₑᵣₑ′, Zₛₚₕₑᵣₑ′) into rectangular coordinates (Xₛₚₕₑᵣₑ′, Yₛₚₕₑᵣₑ′, Zₛₚₕₑᵣₑ′); multiplying the coordinates (Xₛₚₕₑᵣₑ′, Yₛₚₕₑᵣₑ′, Zₛₚₕₑᵣₑ′) by a corresponding rotation matrix resulting from rotating from the main viewpoint center (lon, lat) to the North Latitude 90° or South Latitude 90° to obtain the rotated rectangular coordinates (Xₛₚₕₑᵣₑ∝Yₛₚₕₑᵣₑ, Zₛₚₕₑᵣₑ); then, computing the corresponding longitude-latitude (longitude, latitude) based on the rectangular coordinates (Xₛₚₕₑᵣₑ, Yₛₚₕₑᵣₑ, Zₛₚₕₑᵣₑ).

12. The panoramic video inverse mapping method according to claim 10, wherein the step 2) of computing the included angle Z with the North Latitude 90° or South Latitude 90° based on the Latitude latitude and then determining the area where the current point is located based on the value of Z comprises: .
computing the value of Z based on the equation Z=90°−latitude when the main viewpoint center is at North Latitude 90°; computing the value of Z based on equation Z=latitude+90° when the main viewpoint center is at South Latitude 90°;
when 0°≤Z<Z₁, the current point is located in Area II; when Z₁<Z<Z₂, the current point is located in Area II; when Z₂<Z≤180°, the current point is located in Area III; when Z=Z₁, the current point is located in Area I or Area II; when Z=Z₂ , the current point is located in Area II or Area III.

13. The panoramic video inverse mapping method according to claim 10, wherein the step 3) of computing the distance ρ from the current point mapped to the plane to the center of the plane image B or the shortest distance ρ′ among the distances from the current point mapped to the plane to the four corners of the plane image B based on the area corresponding to the current point and the value of Z specifically comprises:
when the current point is in the Area I, computing ρ based on the equation
$$ρ = {C}_{0} sin \frac{Z}{2} ,$$
wherein C₀ is determined by the boundary condition: when ρ=ρ₀, Z=Z₁;
when the current point is in the Area II, solving ρ based on the equation ρ²=C₁+C₀∫sinZ f₁(Z)dZ , wherein C₀, C₁ is determined by the boundary conditions: when ρ=ρ₀, Z=Z₁ and when ρ=1, Z=Z₂ ; and f₁(Z) is any function of Z;
when the current point is in the Area III, solving ρ′ based on the equation ρ′²=C₁+C₀∫sinZ f₂(Z) dZ , wherein C₀, C₁ is determined by the boundary conditions: when ρ′=0, Z=180° and when ρ′=\sqrt{2}−1, Z=Z₂; and f₂(Z) is any function of Z.

14. The panoramic video inverse mapping method according to claim 10, wherein the step 4) of solving the value of coordinates (X, Y). Specifically comprises:
when the point is located in Area I or II, obtaining the included angle between the current point and the direction of longitude of 0° chosen from the Area I or the Area II on the plane based on longitude, and then solving the value of the coordinates (X, Y) of the current point mapped to the plane based on the value of the included angle and the value of ρ;
when the point is located in Area III, obtaining the value of the coordinates (X, Y) of the current point mapped to the plane based on the values of longitude and ρ′ and the angles corresponding to the four ¼ circles.
